(19) United States
(12) Patent Application Publication
(10) Pub. No.: US 2026/0255015 A1
(43) Pub. Date: Aug. 27, 2026

(54) TV/STB VOLUME/CAPTIONS AUTO ADJUSTMENT WITH MMWAVE - FALL DETECTION USING MMWAVE

(71) Applicant: DISH Network Technologies India Private Limited, Bengaluru (IN)

(72) Inventors: Srinivasarao Duddu, Bengalore (IN); Ananda Siddappa, Bengalore (IN)

(21) Appl. No.: 19/319,379

(22) Filed: Sep. 4, 2025

(30) Foreign Application Priority Data
Feb. 24, 2025 (IN) 202541016092

(51) Int. Cl. H04N 21/442; H04N 21/466

(52) U.S. Cl. CPC H04N 21/44218; H04N 21/4662

(57) ABSTRACT

A method may include receiving, by a wireless module located within a room, a return signal associated with a transmitted signal, the return signal reflected off an object within the room. The method may include determining data associated with the object based at least in part on the return signal. The method may include determining, by a machine learning module, a characteristic of the object based at least in part on the data associated with the object, where an output of the machine learning module indicates the characteristic of the object and a location within the room. The method may include determining, by the machine learning module, actions to be performed based at least in part on the characteristic of the object. The method may include transmitting an output signal indicating the actions to be performed to respective devices, based on the actions to be performed.

### CROSS REFERENCE TO RELATED APPLICATIONS

This application claims priority to Indian Provisional Patent Application No. 202541016092, filed on Feb. 24, 2025, in the Indian Intellectual Property Office, the disclosure of which is incorporated by reference in its entirety for all purposes.

### BACKGROUND OF THE INVENTION

Various systems have been utilized for monitoring and responding to an object's characteristic, such as a person's position, a movement, an orientation, or a vital sign. However, existing solutions may be suboptimal for a number of reasons. For instance, existing solutions often require manual interaction via physical hardware, are limited in providing seamless and automated responses to dynamic situations, raise privacy concerns, require excessive power, or excessively consume network bandwidth.

### BRIEF SUMMARY

A method may include receiving, by a wireless module of a computing system located within a room, a return signal associated with a transmitted signal, the return signal reflected off an object within the room. The method may include determining, by the computing system, data associated with the object based at least in part on the return signal. The method may include determining, by a machine learning module executed on the computing system, a characteristic of the object based at least in part on the data associated with the object, where an output of the machine learning module indicates the characteristic of the object and a location within the room. The method may include determining, by the machine learning module executed on the computing system, one or more actions to be performed based at least in part on the characteristic of the object. The method may include transmitting, by the computing system, an output signal indicating the one or more actions to be performed to one or more respective devices, based at least in part on the actions to be performed.

In some embodiments, the computing system may include at least one of a set top box or a television. The characteristic may include at least one of a position, a movement, an orientation, or a vital sign. The transmitted signal may include a 24 ghz mmwave radar signal. The transmitted signal is an ultra-wideband signal. The method may include transmitting, by the computing system, a radar signal. The transmitted signal may be transmitted by the wireless module of the computing system. The one or more actions may include at least one of adjusting a power state of the computing system, adjusting a volume of the computing system, adjusting a playback state of the computing system, adjusting a caption setting of the computing system, or transmitting an alert to an emergency response system. The system may include a television. The system may include a set top box. The machine learning module may be implemented in an edge device. The machine learning module may be implemented on a remote computing device. The wireless module may include a radar sensor.

A system may include a wireless module, a machine learning module, one or more processors and a non-transitory computer readable medium including instructions that, when executed by the one or more processors, cause the system to receive, by a wireless module of a computing system, a return signal associated with a transmitted signal, the return signal modified by an object. The system may determine, by the computing system, data associated with the object based at least in part on the return signal. The system may determine, by a machine learning module executed on the computing system, a characteristic of the object based at least in part on the data associated with the object, where an output of the machine learning module indicates the characteristic of the object. The system may determine, by the machine learning module executed on the computing system, one or more actions to be performed based at least in part on the characteristic of the object. The system may transmit, by the computing system, an output signal indicating the one or more actions to be performed to one or more respective devices, based at least in part on the actions to be performed.

A non-transitory computer-readable medium may include instructions that, when executed by the one or more processors, cause the one or more processors to perform operations. The operations may include receiving, by a wireless module of a computing system located within a room, a return signal associated with a transmitted signal, the return signal reflected off an object within the room. The operations may include determining, by the computing system, data associated with the object based at least in part on the return signal. The operations may include determining, by a machine learning module executed on the computing system, a characteristic of the object based at least in part on the data associated with the object, where an output of the machine learning module indicates the characteristic of the object and a location within the room. The operations may include determining, by the machine learning module executed on the computing system, one or more actions to be performed based at least in part on the characteristic of the object. The operations may include transmitting, by the computing system, an output signal indicating the one or more actions to be performed to one or more respective devices, based at least in part on the actions to be performed.

### BRIEF DESCRIPTION OF THE DRAWINGS

FIG. 1 illustrates a system and a process for performing actions using wireless signals, according to certain embodiments.

FIG. 2 illustrates an example computing system, according to certain embodiments.

FIGS. 3A-B illustrate system for performing actions using wireless signals, according to certain embodiments.

FIG. 4 relates to a training process of a machine learning algorithm, according to certain embodiments.

FIG. 5 illustrates an example computing system, according to certain embodiments.

### DETAILED DESCRIPTION

The ability to detect and respond to environmental changes or the presence of objects remains limited, particularly when relying on conventional technologies. For instance, media devices such as televisions typically require user input through remote controls, voice commands, or other manual interfaces to adjust settings like volume, a power state (e.g., on/off), or other setting. Such systems often fail to provide a seamless or adaptive user experience and may be inaccessible for individuals with physical or cognitive limitations. For example, a user of a television may fall asleep with the television on. While sleep timers have been in use for decades, they are dependent on a person setting the timer in the first place. Sleep timers are not “smart,” meaning they cannot detect sleep and react accordingly.

Similarly, in emergency response systems, the timely and accurate detection of objects in a given area is critical for sending alerts or initiating appropriate actions. For example, if a person has fallen and cannot get up, the person may be stranded, unable to get assistance. If the person is unconscious, their plight may be even more grave. Existing systems frequently struggle to operate effectively in dynamic or complex environments, where variations in lighting, movement, or background noise can hinder detection accuracy. Thus, there is a pressing need for advanced technologies that can autonomously detect objects, determine relevant characteristics—such as size, location, motion, or identity—and perform contextually appropriate actions based on those characteristics.

One solution may be a system configured to monitor and respond to an object's characteristic, such as a human's position, movement, orientation, or vital sign, without manual input by a user. For example, as will be made more apparent by the following disclosure, a system may transmit a radar signal, receive a return signal reflected off an object, determine a characteristic of the object, determine one or more actions to be performed, and transmit an output signal indicating the action to be performed to a device. Such systems may be utilized in a variety of applications. For instance, in media applications, these systems may be utilized in media devices (e.g., a television or a set top box) to monitor a human's relative distance from the television, and respond by automatically adjusting a device setting (e.g., a volume of the television) without manual input by the human. Similarly, in health and safety monitoring applications (e.g., in residential or assisted living communities), these systems may be utilized in devices (e.g., a television or a set top box) to monitor a human's orientation or vital sign, and respond by sending an alert to an emergency response system. The use of radar signals may also improve privacy concerns by eliminating the need to collect visual or otherwise invasive or identifying data (e.g., images). Such systems may also be configured to reduce power consumption and optimize network bandwidth by, for example, automatically powering off a device when not in use by a human.

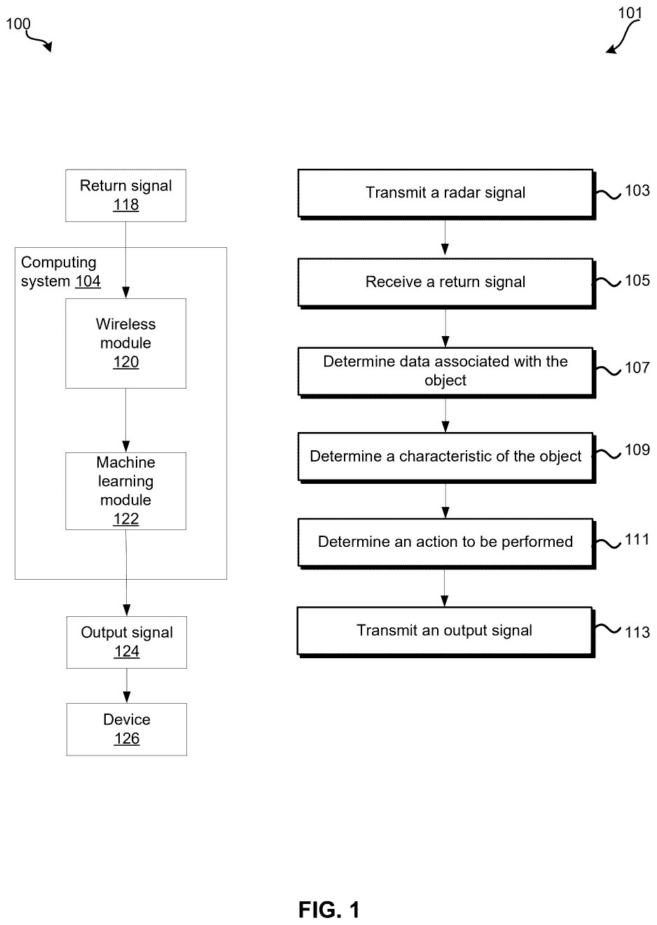

FIG. 1 illustrates a system 100 and a process 101 for performing actions using wireless signals, according to certain embodiments. The system 100 may include a computing system 104, a wireless module 120, a machine learning module 122, and a device 126. Nevertheless, it should be appreciated that the system 100 shown and described is just an example. The system 100 may include any other component, device, system, or element, such as an IoT device, in combination with and/or instead of the components shown in FIG. 1. Furthermore, some or all of the elements shown in FIG. 1 may be reconfigured and/or combined with other elements. For example, the device 126 may be integrated with or separate from the wireless module 120, the machine learning module 122, and/or the computing system 104. The machine learning module 122 may be integrated with or separate from the wireless module 120, the device 126, and/or the computing system 104. Likewise, the wireless module 120 may be integrated with or separate from the machine learning module 122, the device 126, and/or the computing system 104.

The computing system 104 may include one or more computing devices (or other devices) working together and/or separately. For example, the computing system 104 may include a set top box and a television, connected such that the set top box can control one or more functions of the television (e.g., power on/off, volume control, channel tuning, etc.). In another example, the computing system 104 may only include a television. In yet another example, the computing system 104 may include a portable media device, such as a laptop, a tablet, or a smartphone. Further, in yet another example, the computing system 104 may include an emergency alert device (e.g., a computer with a display, a speaker system, and/or an indicator light) configured to receive alerts and notify an emergency responder, such as a police office, firefighter, or caregiver.

The wireless module 120 may include an antenna and/or a receiver configured to transmit and/or receive signals via a variety of protocols, such as FMCW (Frequency Modulated Continuous Wave), CW (Continuous Wave), Doppler Radar, Pulse Radar, Synthetic Aperture Radar (SAR), Phased Array Radar, Ultra-Wideband (UWB), Millimeter Wave (mmWave), LIDAR-integrated Radar, or other suitable protocols. Additionally, other protocols may include Wi-Fi (IEEE 802.11), Bluetooth (Classic and/or BLE), Zigbee, Z-Wave, Cellular (e.g., 4G LTE, 5G, GSM, CDMA), NFC (Near Field Communication), LoRa (Long Range), RFID (Radio Frequency Identification), UWB (Ultra-Wideband), Infrared (IR), Satellite Communication (e.g., GPS, GNSS), Thread, Sigfox, DECT, or WiMAX.

In some embodiments, the wireless module 120 may be implemented in separate devices. For example, a remote control may include a transmitter and a television may include a receiver. The remote control may then transmit a signal to detect one or more objects and the television may receive a return signal, which may be used to determine a characteristic of the object, and ultimately, an action to be performed, such as adjusting a television setting.

In another embodiment, the wireless module 120 may include a wireless access point, transmitting to a receiver (e.g., a set top box). The receiver may then receive a return signal, which may be used to determine a characteristic of the object, and ultimately, an action to be performed, such as adjusting a television setting (e.g., power on/off, volume control, channel tuning, etc.) via a set top box. Thus, the wireless module 120 may determine characteristics etc. of based on the refraction, interference patterns, etc. of objects within the environment.

The machine learning module (MLM) 122 may include a data input interface configured to receive signal data, object data, and/or action data from one or more sources. The MLM 122 may include a pre-processing unit configured to normalize, filter, or otherwise prepare the input data for analysis. The MLM 122 may include one or more machine learning models, such as neural networks, decision trees, support vector machines, or other suitable algorithms, trained to analyze the data and determine one or more characteristics of an object. The MLM 122 may include an output module configured to generate a result and/or trigger one or more actions based on the determined characteristic. The MLM 122 may also include a memory or storage unit for storing training data, model parameters, or configuration settings, and a processing unit configured to execute the various operations of the module. The MLM 122 may also include a feedback mechanism for refining the model based on real-time or post-analysis results and/or user feedback to improve accuracy and performance over time.

The device 126 may include any suitable device for the particular application, such a media device (e.g., television, set top box, laptop, tablet, smartphone), an emergency response system device (e.g., emergency alert device, hospital monitoring device, emergency response monitoring device), or communication and integration devices (e.g., cloud server, edge device). Therefore, and as will be made apparent by the disclosure, the device 126 may be integrated with the computing system 104 or may be a remote device. It should also be appreciated that that while the device 126 is discussed and illustrated in FIG. 1 in the singular form, system 100 may include one device 126 or more than one device 126.

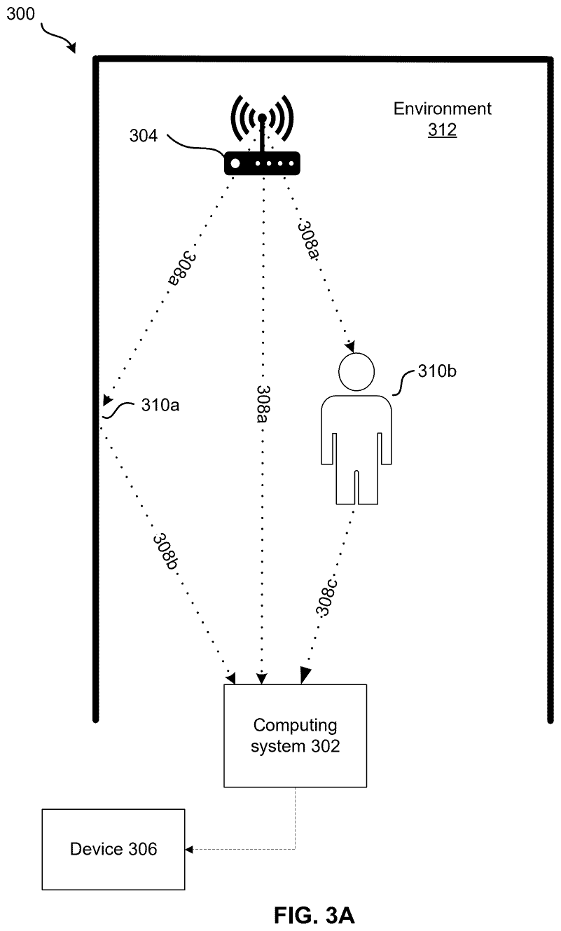

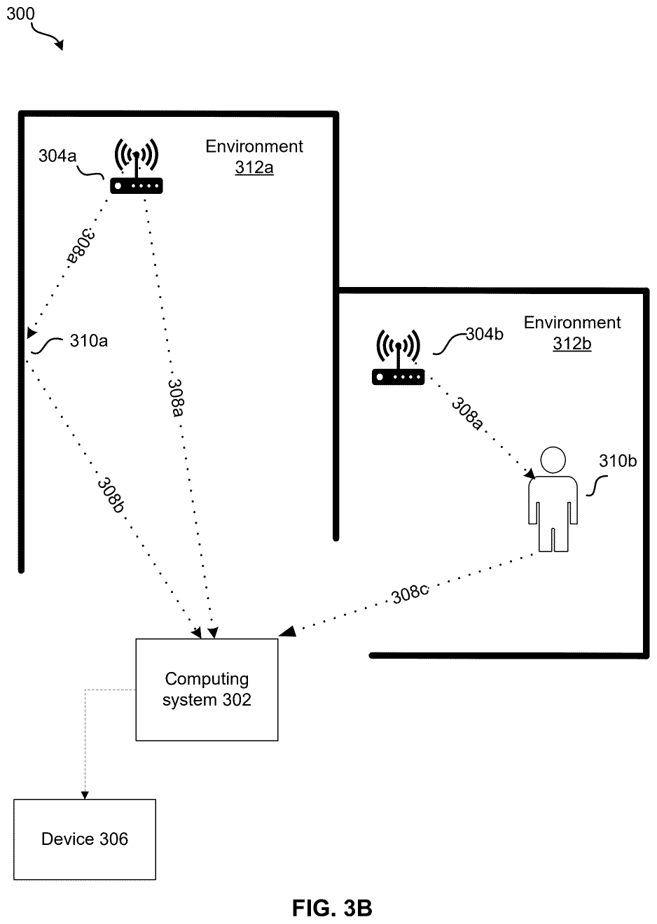

At block 103, a transmitter may transmit a signal, defining the transmitted signal (shown in FIGS. 3A-B). The signal may be a radar signal, an analog signal, a digital signal, a radio frequency (RF) signal, an infrared (IR) signal, an ultrasonic signal, an optical signal, a microwave signal, an electromagnetic signal, an audio signal, a video signal, a Bluetooth signal, a Wi-Fi signal, a cellular signal, a satellite signal, a GPS signal, a near-field communication (NFC) signal, a Zigbee signal, a Z-Wave signal, a LoRa signal, an Ethernet signal, a USB signal, an I2C (Inter-Integrated Circuit) signal, an SPI (Serial Peripheral Interface) signal, a CAN (Controller Area Network) signal, a UART (Universal Asynchronous Receiver-Transmitter) signal, an HDMI signal, a VGA signal, a DVI signal, a power-line communication (PLC) signal, a pulse-width modulation (PWM) signal, a light signal, a magnetic signal, a thermal signal, a bioelectric signal such as an ECG or EEG signal, an acoustic signal, or other suitable signal. The signal may be transmitted by the wireless module 120, and/or by some other device (e.g., a remote control, wireless access point, etc.). The transmitted signal may encounter and reflect off one or more objects (shown in FIGS. 3A-B), and the reflected signal may define a return signal 118.

At block 105, wireless module 120 may receive the return signal 118. The transmitted signal and the return signal 118 may include a variety of signals, depending on the desired range, resolution, environmental conditions, and the type of data to be determined from the return signal 118. For example, in some embodiments, the transmitted signal and/or return signal 118 may include a 24 GHz mmwave radar signal. A 24 GHz mmwave radar signal may be used for short-to-medium range applications, as their high frequency may allow for precise detection of small objects or subtle movements (e.g., a heartbeat). In other embodiments, the transmitted signal and/or return signal 118 may be an ultra-wideband signal. An ultra-wideband signal may be used in environments with obstacles, as their wide bandwidth enables them to differentiate between multiple objects in close proximity and detect objects through walls or other materials. An ultra-wideband signal may also provide for location accuracy within a range of +/−10 cm. This may make ultra-wideband signals useful for applications such as tracking movement in cluttered environments, detecting falls in senior living facilities, or monitoring vital signs without direct contact.

It should also be appreciated that while one or more of the signals (e.g., signal, transmitted signal, return signal 118) are discussed in the singular form, it is not so limited. For example, the transmitter may transmit multiple signals, the computing system 104 may receive one or more than one return signals 118 (sequentially or simultaneously), and each return signal 118 may reflect off one or more than one object. Additionally, the signals transmitted and received may be substantially the same or may vary from one another. Thus, for example, some signals may have a different frequency than others, or each signals may be substantially the same.

The return signal 118 may be reflected off a variety of objects, depending on the particular application. For example, such objects may include living objects or parts thereof, such as living beings (e.g., humans, animals, plants), body parts (e.g., head, hands, feet, arms, legs), or bodily organs (e.g., heart, lungs, brain). Such objects may also include inanimate objects, such as interior objects (e.g., walls, doors, windows, furniture, appliances), natural objects (e.g., water, fire), small or moving objects (e.g., balls, tools, equipment, bags, debris, obstacles, projectiles), vehicles (e.g., car), and/or other suitable objects.

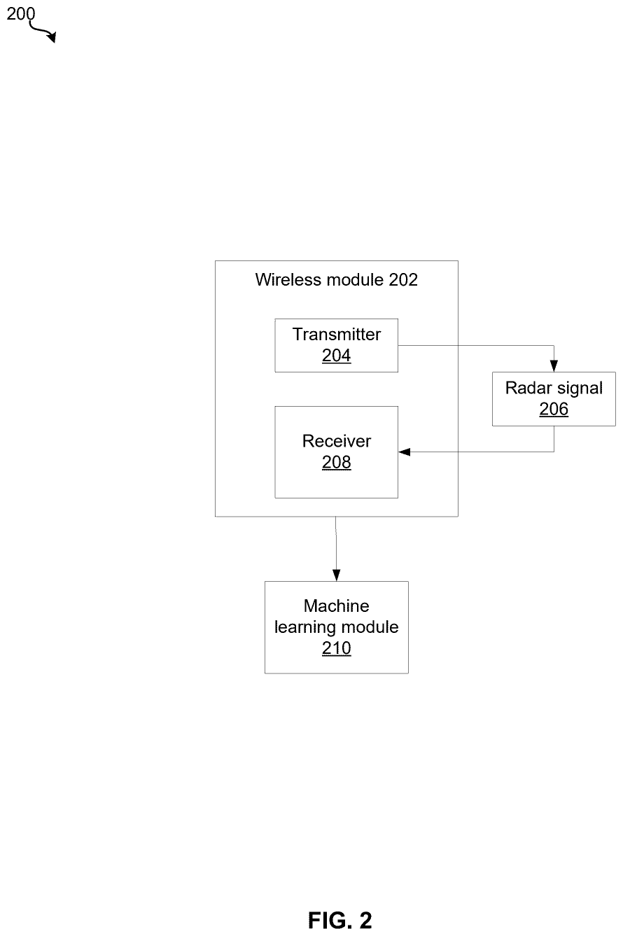

The wireless module 120 may be any hardware component or integrated circuit that enables wireless communication between one or more devices or modules. As will be discussed further in FIG. 2, the wireless module 120 may include a transmitter for transmitting a signal and/or a receiver for receiving a return signal of the transmitted signal. In some embodiments, the wireless module 120 may include a radar sensor. The radar sensor may be any suitable radar sensor for the particular application, and may include, for example, Doppler radar sensors, continuous-wave radar sensors, pulsed radar sensors, frequency-modulated continuous-wave (FMCW) radar sensors, synthetic aperture radar (SAR) sensors, phased-array radar sensors, monopulse radar sensors, or other suitable radar sensors. Wireless module may also work on other protocols, including those previously discussed, such as Wi-Fi (IEEE 802.11), Bluetooth (Classic and BLE), Zigbee, Z-Wave, Cellular (e.g., 4G LTE, 5G, GSM, CDMA), NFC (Near Field Communication), LoRa (Long Range), RFID (Radio Frequency Identification), UWB (Ultra-Wideband), Infrared (IR), Satellite Communication (e.g., GPS, GNSS), Thread, Sigfox, DECT, WiMAX.

At block 107, the computing system 104 may determine data associated with the object, based at least in part on the return signal 118. The data may vary depending on the particular application. The data may include raw signal data. For example, the return signal 118 may provide raw data that includes attributes such as amplitude, phase, frequency, and/or time delay. The raw data may be used to determine information about the object, such as its location, size, velocity, and movement. However, the raw data may be noisy and unstructured, and may be affected by interference from external sources that distort the data (e.g., signals from other devices), clutter (e.g., unwanted signals from unintended objects), and/or overlapping reflections from multiple objects.

In order to convert this into processable data for machine learning (e.g., via the machine learning module 212 or other machine learning module), signal processing techniques may also be applied by the computing system 104, such as filtering, de-noising, time-of-flight analysis, Doppler processing, and/or Fast Fourier Transform (FFT). Such techniques may yield more meaningful data, such as the object's distance, velocity, angle, and/or micro-movements. This processed data may then be structured into a feature set, which may be fed into the machine learning module 212, which may be trained to recognize patterns, classify objects, or predict behaviors.

At block 109, the machine learning module 122 may determine or classify the object (e.g., person, chair, dog, etc.). Then, the MLM 122 may determine one or more characteristics of the object based at least in part on the data associated with the object. For example, the MLM 122 may receive signal data that indicates that an object is present within the room. The MLM 122 may then perform one or more identification or classification techniques (via one or more machine learning models) to determine whether the object is a human (versus another object, such as a chair or dog), based on object data and/or other data used to train the MLM 122 to identify and/or classify such objects. An output of the machine learning module 122 may indicate the characteristic of the object.

The characteristic may depend on the particular application, and may be, for example, a physical characteristic (e.g., size, shape, length), location and/or spatial characteristic (e.g., relative distance, position, relative location, orientation), movement characteristic (e.g., movement, velocity, direction of motion, acceleration, stationary vs. moving), temporal characteristic (e.g., time of detection, duration of presence, movement history, interaction timing), behavioral characteristic (activity type, posture, gesture, inferred behavior), a classification characteristic (e.g., object type, human identification, object role), an anomaly detection characteristic (e.g., abnormal movement patterns, irregular vital signs, unintended behavior), a biological characteristic (e.g., vital sign, breathing rate, heart rate, respiration depth, presence of life, body size, weight, height), a safety characteristic (e.g., collision risk, fall risk, health risk, obstacle detection, attack risk), and/or other suitable characteristic. It should be appreciated that that while the characteristic is discussed in the singular form, the machine learning module 122 may determine one or more characteristics of an object, either sequentially or simultaneously. The MLM 122 may determine the one or more characteristics in real-time (e.g., in less than 1 second, less than 5 seconds, less than 30 seconds, etc.).

At block 111, the machine learning module 122 may determine one or more actions to be performed based at least in part on the characteristic of the object. The action may vary depending on the particular application, and may be, for example, adjusting a power state of the computing system (e.g., on/off), adjusting a volume of the computing system, adjusting a playback state of the computing system (e.g., play, pause, rewind, fast forward), adjusting a caption setting of the computing system (e.g., captions on/off, caption size, caption position, caption language) or transmitting an alert to an emergency response system. Particular examples of such actions being determined at least in part on one or more characteristics will be discussed in connection with FIGS. 3A and 3B.

At block 113, the computing system 104 may transmit an output signal 124 indicating the one or more actions to be performed to one or more devices 126. As noted earlier, the device 126 may be any suitable device for the particular application, such a media device (e.g., television, set top box, laptop, tablet, smartphone), an emergency response system device (e.g., emergency alert device, hospital monitoring device, emergency response monitoring device), or communication and integration devices (e.g., cloud server, edge device).

The output signal 124 may be any signal and may be determined based on the particular application and/or the particular device 126. For example, the output signal 125 may be substantially the same as or different from the transmitted signal and/or return signal 118. In some embodiments, the output signal 125 may be an analog signal, a digital signal, a radio frequency (RF) signal, an infrared (IR) signal, an ultrasonic signal, an optical signal, a microwave signal, an electromagnetic signal, an audio signal, a video signal, a Bluetooth signal, a Wi-Fi signal, a cellular signal, a satellite signal, a GPS signal, a near-field communication (NFC) signal, a Zigbee signal, a Z-Wave signal, a LoRa signal, an Ethernet signal, a USB signal, an I2C (Inter-Integrated Circuit) signal, an SPI (Serial Peripheral Interface) signal, a CAN (Controller Area Network) signal, a UART (Universal Asynchronous Receiver-Transmitter) signal, an HDMI signal, a VGA signal, a DVI signal, a power-line communication (PLC) signal, a pulse-width modulation (PWM) signal, a light signal, a magnetic signal, a thermal signal, a bioelectric signal such as an ECG or EEG signal, an acoustic signal, or other suitable signal.

FIG. 2 illustrates an example computing system 200, according to certain embodiments. The computing system 200 may include wireless module 202 and machine learning module 210. The computing system 200, wireless module 202, and machine learning module 210 may be similar to the computing system 104, wireless module 120, and machine learning module 122 of FIG. 1, respectively. In some embodiments, the wireless module 202 may include a transmitter 204 and a receiver 208. Additionally, as noted earlier, in some embodiments, the wireless module 202 may include a radar sensor, which may include the transmitter 204 and/or the receiver 208. The transmitter 204 may be configured to transmit a signal 206, defining the transmitted signal. As described earlier, the transmitted signal may encounter and reflect off one or more objects, and the reflected signal may define a return signal. The receiver 208 may be configured to receive the return signal of the signal 206.

It should be appreciated that the computing system 200 shown and described is just an example. The computing system 200 may include any other component, device, system, or element, such as an IoT device, in combination with and/or instead of the components shown in FIG. 2. Furthermore, some or all of the elements shown in FIG. 2 may be reconfigured and/or combined with other elements. For example, the transmitter 204 may be integrated with or separate from the computing system 200, the wireless module 202, the receiver 208, and/or the machine learning module 210. Similarly, the receiver 208 may be integrated with or separate from the computing system 200, the wireless module 202, the transmitter 204, and/or the machine learning module 210. It should therefore be apparent that the transmitter 204 and the receiver 208 may be integrated into a single device, or separately integrated into one or more remote devices.

For example, the receiver 208 may be integrated into a television and the transmitter 204 may be integrated into a remote control that is separate from the television. The remote control may then transmit a signal to detect one or more objects and the television may receive a return signal, which may be used to determine a characteristic of the object, and ultimately, an action to be performed, such as adjusting a television setting. Alternatively, the receiver 208 may be integrated into a television and the transmitter 204 may be integrated into a set top box that is separate from the television and can control one or more functions of the television (e.g., power on/off, volume control, channel tuning, etc.). The receiver 208 and the transmitter 204 may also be integrated into a single device, such as a television, set top box, or other device.

The MLM 210 may include one or more machine learning models configured to perform various tasks. For example, a first model may be configured to identify and/or classify an object. The first model may include one or more machine learning models, such as a support vector machine, an imbalanced classification model, a multi-label classification model, a binary classification model, and/or any other suitable model. The first model may be trained using signal data (and/or other data) corresponding to objects such as persons, furniture, animals, or other objects, such as time-domain waveforms, frequency-domain data (e.g., Fourier-transformed signals), amplitude data. The training process may utilize supervised, unsupervised, or reinforcement learning techniques, leveraging datasets that include labeled and/or unlabeled data.

When input data is provided to the first model, it may process the data through feature extraction techniques, such as edge detection, histogram of oriented gradients (HOG), principal component analysis (PCA), and/or convolutional feature maps. These extracted features may then be analyzed using classification algorithms, such as decision trees, random forests, k-nearest neighbors, or deep neural networks, to determine that the data corresponds to an object such as a person, animal, or other relevant object. To enhance accuracy and reliability, the first model may incorporate pre-processing techniques, such as noise reduction, data normalization, or dimensionality reduction, and may dynamically adjust its parameters based on real-time data inputs.

The MLM 210 may also include a second model configured to determine one or more characteristics of identified and/or classified objects. The second model may include one or more machine learning models, such as support vector regression (SVR), decision trees, deep neural networks, or other suitable models. The second model may be trained using object data (and/or other data), such as size data, shape data, length data, or velocity data. The training process may utilize supervised, unsupervised, or reinforcement learning techniques, leveraging datasets that include labeled and/or unlabeled data.

When provided with input data, the second model may analyze the data using feature extraction techniques, such as scale-invariant feature transform (SIFT), spectral analysis, texture mapping, or any other suitable method. The extracted features may then be processed to determine one or more characteristics of the object, such as size, shape, velocity, or trajectory. To enhance accuracy and reliability, the second model may incorporate pre-processing techniques, such as data filtering, noise reduction, or enhancement, and may dynamically adjust its parameters based on real-time data inputs.

The MLM 210 may also include a third model configured to determine one or more actions to be performed based on the characteristics of an identified and/or classified object. The third model may be trained using action data (and/or other data), such as power state adjustment data, volume adjustment data, or alert transmission data. Additionally, the training process may incorporate rules-based filters to prioritize or refine decision-making. The third model may include one or more machine learning models, such as reinforcement learning models, Markov decision processes (MDPs), rule-based systems, or other suitable decision-making algorithms.

When provided with input data, the third model may analyze the characteristics of the object (e.g., size, shape, speed, or material composition) alongside contextual parameters and environmental signals. The third model may then determine one or more actions to be performed. For example, the model may adjust the power state of a device when the object is identified as being inactive for a prolonged period, reduce playback volume when the object is characterized as a sleeping person, or transmit an alert when a hazardous object is detected. To enhance accuracy and reliability, the third model may incorporate pre-processing techniques, such as data normalization or prioritization of action rules, and may adapt its decision-making processes over time by incorporating feedback or newly available action data.

FIGS. 3A-B illustrate systems 300 for performing actions using wireless signals, according to certain embodiments. As shown in FIG. 3A, one or more elements of the system 300, such as the computing system 302, the transmitter 304, and/or the device 306, may be within an environment 312. Nevertheless, it should be appreciated that one or more of these elements may be remote from the environment 312, depending on the particular application. The computing system 302, transmitter 304, and device 306 may be similar to those already discussed in connection with FIGS. 1-2.

The environment 312 may be any suitable environment depending on the particular application, and does not necessarily need to be a fully enclosed space or indoor space. For example, environment 312 may be a residential environment (e.g., a home, a room of a home, some portion of an assisted living facility, etc.), a commercial environment (e.g., an office), an industrial environment, an outdoor environment, or an indoor environment. The environment 312 may also be, for example, a high-security environment, a warehouse environment, a retail environment, a healthcare environment (e.g., a hospital), a laboratory environment, a transportation environment (e.g., in vehicles or trains), a smart home environment, an agricultural environment, a military environment, a construction environment, a hazardous environment such as areas with flammable materials. Further, the environment 312 may also be a public space environment such as parks or streets, a sports or fitness environment, an educational environment, an entertainment environment such as theaters, a museum or cultural environment, a hospitality environment such as hotels, or other suitable environment.

The transmitter 304 may transmit a signal, defining one or more transmitted signals 308a. The one or more transmitted signals 308a may encounter and reflect off one or more objects 310a-b and the reflected signal(s) may define one or more respective return signals 308b-c. It should be appreciated that the number of transmitted signals 308a may vary depending on various factors, such as the capability of the transmitter 304 used, or the needs for the particular application. Likewise, the number of return signals 308b-c may vary depending, among other things, the number of objects 310a-b in the environment 312. Thus, while the one or more objects in FIG. 3A-B include a wall surface (shown as object 310a) and a human (shown as object 310b), the objects 310a-b may be any other object, including those previously discussed. Additionally, while only two objects 310a-b are illustrated, any number of objects may be within the environment (e.g., multiple humans, with each human being associated with one or more respective characteristics and one or more respective actions to be performed). As described earlier, the computing system 302 may receive the one or more return signals 308b-c, determine a characteristic of the one or more objects 310a-b, determine one or more actions to be performed, and transmit an output signal indicating the action to be performed to a device 306.

In the example shown in FIG. 3A, the environment 312 may be a room of a residential home, the object 310a may be a wall surface of the room, the object 310b may be a human within the room, and the device 306 may be a television within the room. In such an application, one action to be performed may be adjusting a power state (e.g., on/off) of the television based at least in part on the human's location and/or spatial characteristic (e.g., relative distance, position, relative location, orientation) relative to the room. This may be useful for, among other things, reducing power consumption and optimizing network bandwidth. In an embodiment, the television may automatically turn off as the human exceeds a certain distance from the television or leaves the room, and may automatically turn on as the human is within a certain distance of the television or enters the room.

For example, a first return signal may indicate that no human is present in the room. A later signal may then indicate that a human has entered the room. The computing system 302 may then perform localization and ranging techniques to determine a position and/or range of the human to the television. The computing system 302 may then send an output signal to the television to turn on the television based on the human's position and/or range relative to the television.

In another embodiment, the television may automatically turn off and on based the human's orientation. This may be useful, for example, if the human lays down to fall asleep, in which case the television may automatically turn off, or if the human is sitting down or standing up, in which case the television may automatically turn on. In another example, the television may automatically turn on if the human is seated on a couch or other designated seating area, and may automatically turn off if the human is standing up and walking away from the television.

Another action to be performed may be adjusting a power state (e.g., on/off) of the television based at least in part on the human's classification characteristic (e.g., object type, human identification). For instance, the television may automatically turn off when the human is not identified within the room, and may automatically turn on when the human is identified in the room. This may be useful for reducing power consumption and optimizing network bandwidth. Machine learning may also be utilized to assist in human identification by, for example, recognizing certain vital signs or other biological characteristics associated with the human, allowing for greater personalization.

For example, one or more return signals may indicate that an object is present in the room. The computing system 302 may then perform one or more identification or classification techniques (via a machine learning module) to determine whether the object is a human. The computing system 302 may then send an output signal to the television to turn on the television if a human is detected.

Further, another action to be performed may be adjusting a volume of the television based at least in part on the human's location and/or spatial characteristic (e.g., relative distance, position, relative location, orientation) relative to the room. For instance, the volume of the television may automatically increase as the human moves farther away from the television, and the volume may automatically decrease as the human moves closer to the television. The volume may automatically turn off as the human exceeds a certain distance from the television or leaves the room, and may automatically turn on when the human is within a certain distance within the television or enters the room. This may be useful for reducing power consumption and optimizing network bandwidth. The particular volume level may also be calibrated to an individual's hearing capability (e.g., to account for hearing loss), allowing for greater personalization. Machine learning may also be utilized to determine the optimal volume based on an individual's hearing capability and/or protect the individual from hearing loss.

For example, a first return signal may indicate that a human is in a first location within the room. A later signal may then indicate that the human is in a second location within the room. The computing system 302 may then determine the change in distance relative to the television and/or the velocity of the human. The computing system 302 may then send an output signal to adjust the volume of the television based on the change in distance, for example, by increasing the volume to account for an increase in distance from the television and/or the human's velocity, or decreasing the volume to account for a decrease in distance from the television and/or the human's velocity.

Further, another action to be performed in this application may be adjusting a caption setting based at least in part on the human's location and/or spatial characteristic (e.g., relative distance, position, relative location, orientation) relative to the room. For instance, the caption size displayed on the television may automatically decrease as the human moves closer to the television, or the caption size may automatically increase as the human moves farther away from the television. The captions may also automatically turn on or off when the human is within a certain distance from the television, or enters or leaves the room. The position of the caption on the television screen may also automatically adjust depending on the human's orientation or other spatial characteristic. For example, the captions may be automatically positioned near the top of the television screen when the human is standing, and may be automatically positioned in a lower portion of the screen when the human is laying down.

Further, another action to be performed in this application may be adjusting a playback state of the television based at least in part on the human's location and/or spatial characteristic (e.g., relative distance, position, relative location, orientation) relative to the room. For instance, the television may automatically pause as the human exceeds a certain distance from the television or leaves the room, and may automatically play as the human is within a certain distance of the television or enters the room. The television may also automatically rewind to account for the duration the human exceeded the pre-determined distance from the television or left the room.

Further, another action to be performed in this application may be adjusting a television setting (e.g., volume, captions, playback state) based at least in part on the human's behavioral characteristic (e.g., activity type such as sleeping). For example, the volume and/or captions of the television may automatically turn off when the human is determined to be sleeping, and may automatically turn on when the human is determined to be awake. This may also be useful for reducing power consumption and optimizing network bandwidth.

For example, one or more return signals may indicate that a human is present in the room. The computing system 302 may then perform one or more behavioral classification techniques (via a machine learning module trained by human behavioral data) to determine whether the human is engaging in a predetermined activity (e.g., sleeping). The computing system 302 may then send an output signal to the television to turn off the television if the human is determined to be sleeping.

Further, another action to be performed in this application may be adjusting a television setting (e.g., volume, captions, playback state) based at least in part on the human's behavioral characteristic (e.g., gesture, posture, inferred behavior). For example, the volume, captions, and/or playback state of the television may automatically adjust off when the human performs a predetermined gesture (e.g., raising a hand to increase a volume of the television, giving a thumbs up gesture to play the television, giving a stop gesture to pause the television). Machine learning may also be utilized to determine or infer behavior based on the human's movements, allowing for greater personalization.

Further, another action to be performed in this application may be adjusting a television setting (e.g., volume, captions, playback state) based at least in part on the location and/or spatial characteristic (e.g., relative distance, position, relative location, orientation) of one or more walls in combination with other objects in the room. For example, the volume and/or captions of the television may automatically adjust based on the size of the room, in part by determining the relative positioning and distance of one or more walls. Thus, the volume of the television may increase and/or the caption size may increase in a larger room or if more humans or other objects are detected within the room, and the volume the volume of the television may decrease and/or the caption size may decrease in a smaller room or if more humans or other objects are detected within the room.

For example, one or more first return signals may indicate that the room is enclosed by one or more walls and a human is present within the room. The computing system 302 may then analyze the distances of each wall relative to the television to determine the size of the room, and a first volume setting based on the size of the room and/or the number of humans present. The computing system 302 may then send a first output signal to the television to adjust the volume of the television to the first volume setting. Additionally, one or more second return signals may then indicate that multiple humans are present within the room. The computing system 302 may then determine a second volume setting based on the size of the room and/or the number of humans present. The computing system 302 may then send a second output signal to the television to adjust the volume of the television to the second volume setting.

Further, another action to be performed in this application may be adjusting a television setting (e.g., volume, captions, playback state) based at least in part on the human's biological characteristic. For example, the volume and/or captions of the television may automatically adjust based on the human's body size, height, and/or weight. Thus, the volume of the television may increase and/or the caption size may increase for humans of a certain body size, height, and/or weight, and the volume of the television may decrease and/or the caption size may decrease for humans of a different body size, height, and/or weight. It should be appreciated that different frequency ranges may be utilized for different body sizes, heights, and/or weights. Machine learning may also be utilized to determine television setting preferences based on the human's body size, height, and/or weight, allowing for greater personalization.

For example, one or more first return signals may indicate that a human is present in the room. The computing system 302 may then determine the human's body size, height, and/or weight at least partially by the one or more first return signals, which may have a frequency that corresponds to a relatively smaller human, and determine an appropriate volume setting for that human. The computing system 302 may then send a first output signal to the television to adjust the volume of the television to the determined setting.

In another example, environment 312 may be a room of a residential home, object 310a may be a wall surface of the room, object 310b may be a human within the room, and device 306 may be an emergency response device in a remote location. In such an application, one action to be performed may be transmitting an alert to the emergency response device based at least in part on the human's biological characteristic (e.g., vital sign, breathing rate, heart rate, respiration depth, presence of life, body size, weight, height). For instance, an alert may be automatically transmitted to the emergency response device when the human has determined to have fallen down, stopped breathing, or otherwise incurred an injury requiring emergency assistance. The emergency response device may be remote from the room, and may be located in a hospital, police station, fire station, or other emergency response location. Thus, the transmitted alert may enable one or more emergency responders to address the issue that triggered the alert. This may be particularly useful in assisted living communities, hospitals, or similar settings. Machine learning may also be utilized to distinguish normal biological characteristics (e.g., normal heart rates, normal breathing rates) from abnormal biological characteristics that require attention.

For example, one or more first return signals may indicate that a human is present in the room, and may indicate one or more movements of the human's chest. One or more second return signals may indicate that a human is present in the room but no further indication of movements of the human's chest. The computing system 302 may then perform one or more biological classification techniques (via a machine learning module trained by human biological data) to determine a breathing pattern of the human and whether the human requires emergency assistance. The computing system 302 may then send an output signal to transmit an alert to the emergency response device.

Further, in another example, one or more first return signals may indicate that a human is present in the room, and may indicate the human's body size, weight, and/or height. One or more second return signals may indicate that the human is present in the room, and may indicate a change in the human's weight. The computing system 302 may then perform one or more biological classification techniques (via a machine learning module trained by human biological data) to determine whether the change in human weight requires emergency assistance. The computing system 302 may then send an output signal to transmit an alert to the emergency response device.

Another action to be performed in this application may be transmitting an alert to the emergency response device based at least in part on a safety characteristic of the human (e.g., collision risk, fall risk, health risk, obstacle detection, attack risk). For instance, an alert may be automatically transmitted to the emergency response device if an intruder poses an attack risk or if an object poses a fall risk. This may be particularly useful in residential homes, assisted living communities, or similar settings. Machine learning may also be utilized to distinguish a safety risk from an otherwise acceptable situation.

For example, a first return signal may indicate that a first human is within the room. A later signal may then indicate that a second human is within the room. The computing system 302 may then perform one or more identification or classification techniques (via a machine learning module trained by human behavioral data) to determine whether the first and second humans pose a threat to one another based on inferred behavior. The computing system 302 may then send an output signal to transmit an alert to the emergency response device, if a threat is detected.

It should be appreciated that these examples are merely intended to describe a few examples and applications of the disclosed technology, and to facilitate the understanding of the disclosed technology. As described earlier, there are a variety of object characteristics that may be determined, actions that may be performed, and configurations of systems, devices, and elements of the disclosed technology that may be utilized. Thus, there are numerous different examples and applications of the disclosed technology, one or more (or all) of which may be integrated into a single embodiment.

FIG. 3B illustrates a system 300 with object 310a and transmitter 304a within environment 312a, and object 310b and transmitter 304b within environment 312b. Nevertheless, as with FIG. 3A, any of the elements of system 300 may be within environment 312a, within environment 312b, or remote from environment 312a and environment 312b. By comparing FIG. 3A with FIG. 3B in light of the previous examples, it should be appreciated that some objects (e.g., object 310b, shown as a human) may move between environment 312a and environment 312b, while other objects (e.g., object 310a, shown as a stationary wall surface) may not. It should also be apparent that as object 310b enters environment 312b, object 310b may be outside of the detection range of transmitter 304a and inside the detection range of transmitter 304b. Thus, one or more transmitters may be positioned within one or more environments 312a-b to optimize the detection range and functionality for the particular application. Additionally, as previously discussed, one or more actions may be performed on device 306 when object 310b moves between environment 312a and environment 312b. For instance, if device 306 is within environment 312a, and object 310B leaves environment 312a and enters environment 312b, one or more actions may be performed on the device via computing system 302, such as increasing a volume of a television.

Because transmitters 304a-b utilize signals (e.g., radar signals), rather than more invasive data (e.g., images), the system 300 may be implemented in a variety of different environments where privacy be more of a concern, such as bathrooms or bedrooms. This may be particularly applicable to personal and multi-room environments, such as a home with a living room and a bathroom, an office building with offices and bathrooms, or a hospital with personal rooms and bathrooms.

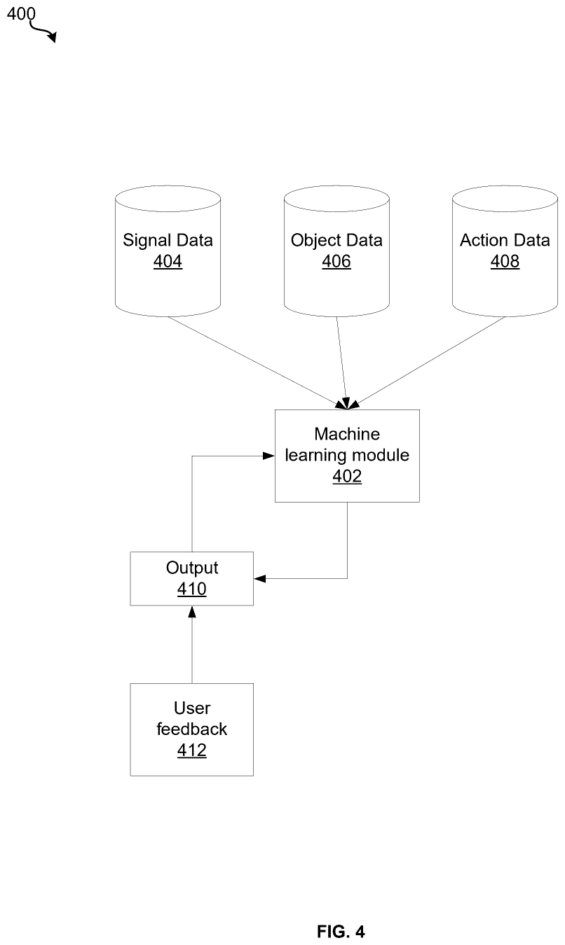

FIG. 4 illustrates a training process of a machine learning algorithm, according to certain embodiments. As shown, system 400 may have various datasets that may be used for training a machine learning module 402, such as signal data 404, object data 406, action data 408, and/or other suitable data. The machine learning module 402 may include one or more machine learning algorithms, and may be similar to the machine learning module discussed in connection with FIGS. 1-3B (e.g., the MLM 210). In some embodiments, the machine learning module may be implemented in an edge device. In other embodiments, the machine learning module may be implemented on a remote computing device. The edge device and/or the remote computing device may be any suitable device, depending on the particular application, and may be one or more of the devices already discussed herein.

The signal data 404 may include information related to raw signal data, such as time-domain waveforms, frequency-domain data (e.g., Fourier-transformed signals), amplitude data, phase data, in-phase (I) and quadrature (Q) components, signal-to-noise ratio (SNR), polarization data, chirp data (e.g., frequency modulation over time in FMCW systems), pulse data (e.g., timing and characteristics of radar pulses), echo signal data (reflected radar signals from objects), noise data (environmental or system-generated), clutter data (unwanted reflections from terrain or other objects), and other raw signal data. In some embodiments, the signal data 404 may be further processed for machine learning using one or more signal processing techniques, such as filtering, de-noising, time-of-flight analysis, Doppler processing, and/or Fast Fourier Transform (FFT). Thus, signal data 404 may also include information related to processed signal data, such as range measurements of detected objects, range profiles (distribution of detected objects at different distances), velocity data (e.g., Doppler shift, relative speed), angular data (e.g., azimuth and elevation angles), object presence or absence, object trajectories over time, multi-object tracking data (e.g., IDs, positions, and velocities), object classifications (e.g., car, pedestrian, cyclist), object features (e.g., shape, size, reflectivity), 3D spatial data (e.g., point clouds or high-resolution mapping), time-series data from continuous radar measurements, and synthetic or augmented data (e.g., simulated radar responses for training).

The signal data may be used to train one or more machine learning models by serving as input features and/or ground truth labels for supervised or unsupervised learning tasks. For example, as noted earlier, raw data such as time-domain waveforms, frequency-domain data, amplitude, phase, and I/Q components may provide signals that can be pre-processed using techniques like filtering, de-noising, and Fourier Transform to extract meaningful patterns and reduce noise. Processed data, including range measurements, velocity, angular, and trajectory data, may serve as structured inputs, enabling the model to learn relationships between signals and real-world object characteristics. For instance, Doppler data may help train models to estimate object velocity, while range profiles and 3D spatial data may support object detection, classification, and tracking tasks, such as identifying whether an object is a human or an animal. Additionally, synthetic or augmented data may be incorporated to enhance training robustness by simulating diverse environmental conditions and edge cases. By leveraging this comprehensive dataset, machine learning models may be designed to detect and classify objects and predict actions with higher accuracy.

The object data 406 may include information related to a characteristic of one or more objects, such as physical characteristic data (e.g., size, shape, length), location and/or spatial characteristic data (e.g., relative distance, position, relative location, orientation), movement characteristic data (e.g., movement, velocity, direction of motion, acceleration, stationary vs. moving), temporal characteristic data (e.g., time of detection, duration of presence, movement history, interaction timing), behavioral characteristic data (e.g., activity type, posture, gesture, inferred behavior), classification characteristic data (e.g., object type, human identification, object role), anomaly detection characteristic data (e.g., abnormal movement patterns, irregular vital signs, unintended behavior), biological characteristic data (e.g., vital sign, breathing rate, heart rate, respiration depth, presence of life, body size, weight, height), safety characteristic data (e.g., collision risk, fall risk, health risk, obstacle detection, attack risk), and/or other

### Characteristic Data.

The object data may be used to train the one or machine learning models to build predictive, classification, and/or detection capabilities. For example, physical characteristics (e.g., size, shape, and length) and spatial data (e.g., relative distance and orientation) may provide foundational information for object recognition and spatial mapping. Movement data, such as velocity or acceleration, may be used for training models to predict object trajectories, detect stationary versus moving objects, or estimate collision risks. Temporal data, such as detection duration or movement history, may be used for training models to learn patterns over time, enabling tasks such as behavior inference or anomaly detection. Behavioral and classification data (e.g., gestures, object type, inferred actions) may be used to train models to identify object roles or human activities. Additionally, biological characteristics (e.g., heart rate, respiration) and safety-related data (e.g., collision or health risks) may be used to train models for health monitoring or risk assessment.

The action data 408 may include information related to one or more actions to be performed based at least in part on an object characteristic, such as power state adjustment data, volume adjustment data, playback state adjustment data, caption setting adjustment data, or alert transmission data.

The action data 408 may be used to train the one or more machine learning module to determine contextually appropriate actions in dynamic situations. For example, object characteristics like detected movement or proximity may serve as input features, while the desired actions, such as adjusting playback volume or transmitting an alert, may act as labels to guide the model's learning. Models may learn to predict or automate contextually appropriate responses by analyzing patterns in how specific actions are triggered by particular object characteristics. Additionally, action data 408 may support reinforcement learning by enabling models to optimize decisions over time based on the outcomes of performed actions, such as minimizing false alerts or improving user experience.

The signal data 404, the object data 406, and/or the action data 408 may be provided to the machine learning module 402, where one or more machine learning algorithms process and analyze the signal data 404, the object data 406, and/or the action data 408 to yield an output 410. The output 410 may include any suitable output for the particular application, such as one or more object characteristics and/or one or more actions to be performed, such as those previously described. The output 410 may be transmitted via an output signal to one or more devices (shown in FIG. 1), and/or may be fed back into the machine learning module 402 for further processing and to improve its performance.

The output 410 may be evaluated for accuracy via user feedback 412. User feedback 412 may provide corrections or insights, for example, by ensuring the accuracy of the one or more determined object characteristics or the one or more determined actions to be performed, and may include annotations to previously determined results (e.g., a “correct” determination, “false determination”, etc.). For instance, a user may provide feedback regarding the one or more actions to be performed based on one or more determined object characteristics, which may help the machine learning algorithms to determine the suitable action to be performed. Additionally, user feedback 412 may include individual preferences or personalized data, which may help train the machine learning algorithms to provide more personalized output 410. For a user may provide feedback on their preferred volume level, or their individual heartrate data, which may help the machine learning algorithms to determine the suitable action to be performed.

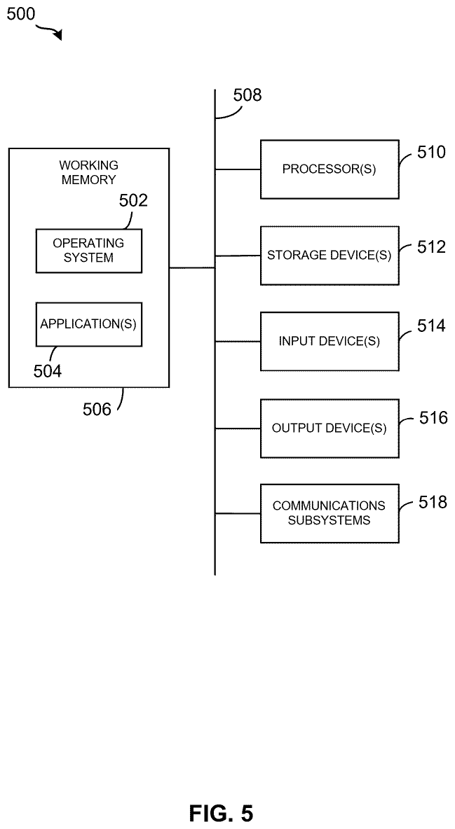

FIG. 5 illustrates an example computing system 500, according to certain embodiments. The computing system 500 is a simplified computing system that can be used to implement various embodiments described and illustrated herein, and may be similar to those previously discussed. A computing system 500 as illustrated in FIG. 5 may be incorporated into devices, including any of the devices previously discussed. FIG. 5 provides a schematic illustration of one embodiment of a computing system 500 that can perform some or all of the steps of the methods and workflows provided by various embodiments. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computing system 500 is shown including hardware elements that can be electrically coupled via a bus 508, or may otherwise be in communication, as appropriate. The hardware elements may include one or more processors 510, including without limitation one or more general-purpose processors and/or one or more special-purpose processors such as digital signal processing chips, graphics acceleration processors, and/or the like; one or more input devices 514, which can include any of the devices previously discussed, such as a radar sensor; and one or more output devices 516, which can include any of the devices previously discussed, such as a television, a set top box, or an emergency response device.

The computing system 500 may further include and/or be in communication with one or more non-transitory storage devices 512, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computing system 500 might also include a communications subsystem 518, which can include without limitation a modem, a network card (wireless or wired), an infrared communication device, a wireless communication device, and/or a chipset such as a Bluetooth™ device, a 802.11 device, a Wi-Fi device, a Wi-Max device, cellular communication facilities, etc., and/or the like. The communications subsystem 518 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 518. In other embodiments, a portable electronic device, e.g., the first electronic device, may be incorporated into the computer system 500, e.g., an electronic device as an input device 514. In some embodiments, the computing system 500 will further include a working memory 506, which can include a RAM or ROM device, as described above.

The computing system 500 also can include software elements, shown as being currently located within the working memory 506, including an operating system 502, device drivers, executable libraries, and/or other code, such as one or more application programs 504, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 5, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 512 described above. In some cases, the storage medium might be incorporated within a computer system, such as computer system 500. In other embodiments, the storage medium might be separate from a computer system, e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computing system 500 and/or might take the form of source and/or installable code, which, upon compilation and/or installation on the computing system 500, e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computing system 500 to perform methods in accordance with various embodiments of the technology. According to a set of embodiments, some or all of the operations of such methods are performed by the computing system 500 in response to processor 510 executing one or more sequences of one or more instructions, which might be incorporated into the operating system 502 and/or other code, such as an application program 504, contained in the working memory 506. Such instructions may be read into the working memory 506 from another computer-readable medium, such as one or more of the storage device(s) 512. Merely by way of example, execution of the sequences of instructions contained in the working memory 506 might cause the processor(s) 510 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 510 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 512. Volatile media include, without limitation, dynamic memory, such as the working memory 506.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 518 and/or components thereof generally will receive signals, and the bus 508 then might carry the signals and/or the data, instructions, etc. carried by the signals to the working memory 506, from which the processor(s) 510 retrieves and executes the instructions. The instructions received by the working memory 506 may optionally be stored on a non-transitory storage device 512 either before or after execution by the processor(s) 510.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method, comprising:
receiving, by a wireless module of a computing system located within a room, a return signal associated with a transmitted signal, the return signal reflected off an object within the room;
determining, by the computing system, data associated with the object based at least in part on the return signal;
determining, by a machine learning module executed on the computing system, a characteristic of the object based at least in part on the data associated with the object, wherein an output of the machine learning module indicates the characteristic of the object and a location within the room;
determining, by the machine learning module executed on the computing system, one or more actions to be performed based at least in part on the characteristic of the object; and
transmitting, by the computing system, an output signal indicating the one or more actions to be performed to one or more respective devices, based at least in part on the actions to be performed.

2. The method of claim 1, wherein:
the computing system comprises at least one of a set top box or a television.

3. The method of claim 1, wherein:
the characteristic comprises at least one of a position, a movement, an orientation, or a vital sign.

4. The method of claim 1 wherein:
the transmitted signal comprises a 24 GHz mmwave radar signal.

5. The method of claim 1, wherein:
the transmitted signal is an ultra-wideband signal.

6. The method of claim 1, further comprising:
transmitting, by the computing system, a radar signal.

7. The method of claim 6, wherein:
the transmitted signal is transmitted by the wireless module of the computing system.

8. The method of claim 1, wherein:
the one or more actions comprise at least one of adjusting a power state of the computing system, adjusting a volume of the computing system, adjusting a playback state of the computing system, adjusting a caption setting of the computing system, or transmitting an alert to an emergency response system.

9. A system, comprising:
a wireless module;
a machine learning module;
one or more processors; and
a non-transitory computer readable medium comprising instructions that, when executed by the one or more processors, cause the system to perform operations to:
receive, by a wireless module of a computing system, a return signal associated with a transmitted signal, the return signal modified by an object;
determine, by the computing system, data associated with the object based at least in part on the return signal;
determine, by a machine learning module executed on the computing system, a characteristic of the object based at least in part on the data associated with the object, wherein an output of the machine learning module indicates the characteristic of the object;
determine, by the machine learning module executed on the computing system, one or more actions to be performed based at least in part on the characteristic of the object; and
transmit, by the computing system, an output signal indicating the one or more actions to be performed to one or more respective devices, based at least in part on the actions to be performed.

10. The system of claim 1, further comprising a television.

11. The system of claim 1, further comprising a set top box.

12. The system of claim 1, wherein:
the transmitted signal comprises a 24 GHz mmwave radar signal.

13. The system of claim 1, wherein:
the transmitted signal is an ultra-wideband radar signal.

14. The system of claim 1, wherein:
the machine learning module is implemented in an edge device.

15. The system of claim 1, wherein:
the machine learning module is implemented on a remote computing device.

16. The system of claim 1, wherein:
the wireless module comprises a radar sensor.

17. The method of claim 9, wherein:
the machine learning module is implemented in an edge device.

18. The method of claim 9, wherein:
the machine learning module is implemented on a remote computing device.

19. A non-transitory computer-readable medium comprising instructions that, when executed by one or more processors, cause the one or more processors to perform operations comprising:
receiving, by a wireless module of a computing system, a return signal associated with a transmitted radar signal, the return signal reflected off an object;
determining, by the computing system, data associated with the object based at least in part on the return signal;
determining, by a machine learning module executed on the computing system, a characteristic of the object based at least in part on the data associated with the object, wherein an output of the machine learning module indicates the characteristic of the object;
determining, by the machine learning module executed on the computing system, one or more actions to be performed based at least in part on the characteristic of the object; and
transmitting, by the computing system, an output signal indicating the one or more actions to be performed to one or more respective devices, based at least in part on the actions to be performed.

20. The non-transitory computer-readable of claim 19, the operations further comprising:
transmitting, by the computing system, a radar signal.
